(19) United States
(12) Patent Application Publication
(10) Pub. No.: US 2019/0095708 A1
(43) Pub. Date: Mar. 28, 2019

(54) SYSTEM AND METHOD FOR CONVERSION BETWEEN TANGIBLE AND ELECTRONIC CALENDARING SYSTEMS

(71) Applicants: Kabushiki Kaisha Toshiba, Minato-ku (JP); Toshiba TEC Kabushiki Kaisha, Shinagawa-ku (JP)

(72) Inventor: Louis M. ORMOND, Irvine, CA (US)

(21) Appl. No.: 15/712,897

(22) Filed: Sep. 22, 2017

(51) Int. Cl. G06K 9/00; G06Q 10/10; G06K 9/22; G06K 9/60

(52) U.S. Cl. CPC G06K 9/00442; G06K 9/60; G06K 9/22; G06Q 10/109

(57) ABSTRACT

A system and method digital conversion of schedule data includes schedule data stored in a data format corresponding to a scheduling application. A digital imager to captures a digital image of a calendar page sheet into a memory and a processor extracts character data from the digital image. The processor parses temporal data from the character data and determines a calendar entry date from parsed temporal data. The processor further parses event data from the character data and updates an electronic calendar entry for a determined calendar entry date with the event data.

### TECHNICAL FIELD

This application relates generally to day planners or calendars used to organize information by day or date. This application relates more particularly to an automated system for transferring information between paper and electronic day planners or calendars.

### BACKGROUND

Calendars have been used for years. A conventional calendar is printed, typically with each month on a separate page wherein each day of each month is provides with an ordered box that can be used to jot notes. A day entry might reflect a time and place for an appointment, or an event like an anniversary or birthday. Boxes can be relatively small and leave room only for an entry or two. A new calendar is typically purchased annually. More recently, day planners came in to use. These are typically in booklet form, such as mounted with a ring binder. Day planners are more compact and conducive to placement on a desk top. Each page may have writing space for one to several days, such that information for only a small number of days appears at once. Unlike calendars wherein an entire month's entries can be viewed at once, day planners require one to turn pages to view other entries for the same month.

More recently, with the advent of computerization, electronic versions of calendars and day planners have come into to use. The look and feel of these electronic counterparts was designed to approximate interaction with their printed predecessors. However, electronic versions had significantly more capability, like an ability to share across different devices, and to allow appointments or notes to be delivered to someone else's electronic calendar.

While electronic calendars and day planners are widely used, there are still a significant number of people who prefer to use the paper versions. They may like to quickly jot notes with a pen or pencil, particularly if they are computer adverse or are inefficient at electronic text entry. Users of manual versions of calendars or day planners are at a disadvantage when they wish to share their notes or appointments with other who use electronic versions. A user of a manual version of a calendar or day planner may also be a user of an electronic version. They would be required to make duplicate entries in both versions which can be time consuming and frustrating.

### SUMMARY

In accordance with an example embodiment of the subject application, a system and method for digital conversion of schedule data includes schedule data stored in a data format corresponding to a scheduling application. A digital imager to captures a digital image of a calendar page sheet into a memory and a processor extracts character data from it. The processor parses temporal data from the character data and determines a calendar entry date from parsed temporal data. The processor further parses event data from the character data and updates an electronic calendar entry for a determined calendar entry date with the event data.

### BRIEF DESCRIPTION OF THE DRAWINGS

Various embodiments will become better understood with regard to the following description, appended claims and accompanying drawings wherein:

FIG. 1 is an example embodiment of a calendaring system 100 for an interchange between paper and electronic calendar systems;

FIG. 2 is an example embodiment of a networked digital device;

FIG. 3 is an example embodiment of a digital processing device;

FIG. 4 is an example embodiment of a paper calendar page; and

FIG. 5 is a flowchart of an example embodiment of a system for calendar conversion.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Digital imaging devices form a bridge between tangible object and digital renderings. A digital camera can instantly generate an electronic image file of any desired object or scene. Scanners can generate image files for one or more written pages. Today, many scanners are incorporated into document processing devices. Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

As used herein, the terms calendar and day planner are interchangeable and define any suitable temporally structured information organization system.

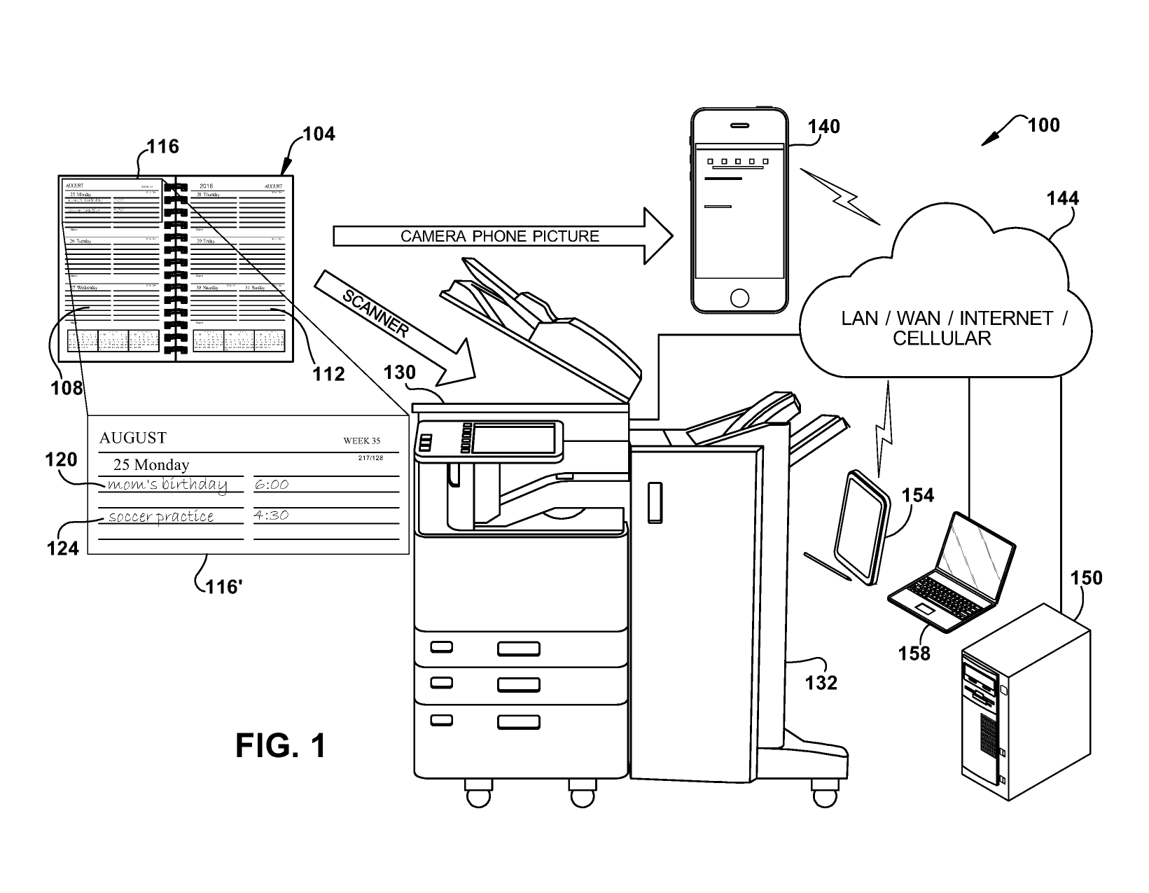

In accordance with the subject application, FIG. 1 illustrates an example embodiment of a calendaring system 100 that functions as an interchange between paper and electronic calendar systems. A paper calendar 104 includes a plurality of entry pages such as pages 108 and 112. A day entry area 116, a magnified version of which appears at 116′, has space for notations, such as printing, writing or graphical entry. In the illustrated example, data entry area 116′ includes two entries 120 and 124 with a notation and corresponding time. Entry 120 is for mom's birthday at 6:00, and appears in printed characters. Entry 124 is for soccer practice at 4:30, and appears in cursive. Any suitable entry or notation can be placed in a space for a particularly day by a user, with or without a corresponding time, duration or location.

One or more pages with one or more entries from calendar 104 is digitally imaged by any suitable imaging device such as with a scanner 130 of MFP 132, or a digital camera, such as one embedded in cell phone 140. Captured images are communicated with any suitable wireless or wired network 144, such a local area network (LAN), wide area network (WAN) which can comprise the Internet, or via a cellular connection, alone or in combination. Capture images are communicated to cloud server 150 wherein information from the image is converted to comprise character based information extracted from the image via optical character recognition (OCR). Cloud server 150 parses resultant character information, which may comprise text derived from printed or written characters in a captured image. As will be detailed below, character information is parsed to determine temporal information, such as the date and time of an entry along with and associated user-supplied content. This information is converted to a format compatible with one or more electronic calendar types, and the information automatically added to one or more electronic calendars. A particular calendar or calendars associated with a particular image may be determent in any suitable fashion, such as a known incoming address or a known incoming phone number. Associated calendars may also be determined by user input, or from the captured image itself, such by captured indicia such as name, phone number, bar code, address or the like. Electronic calendar information is then suitably communicated to any desired device, such as cell phone 140, tablet computer 154 or notebook computer 158. Calendar information may also be communicated for storage or distribution by MFP 132, which may also printout a tangible copy to supplement the original paper calendar page or pages.

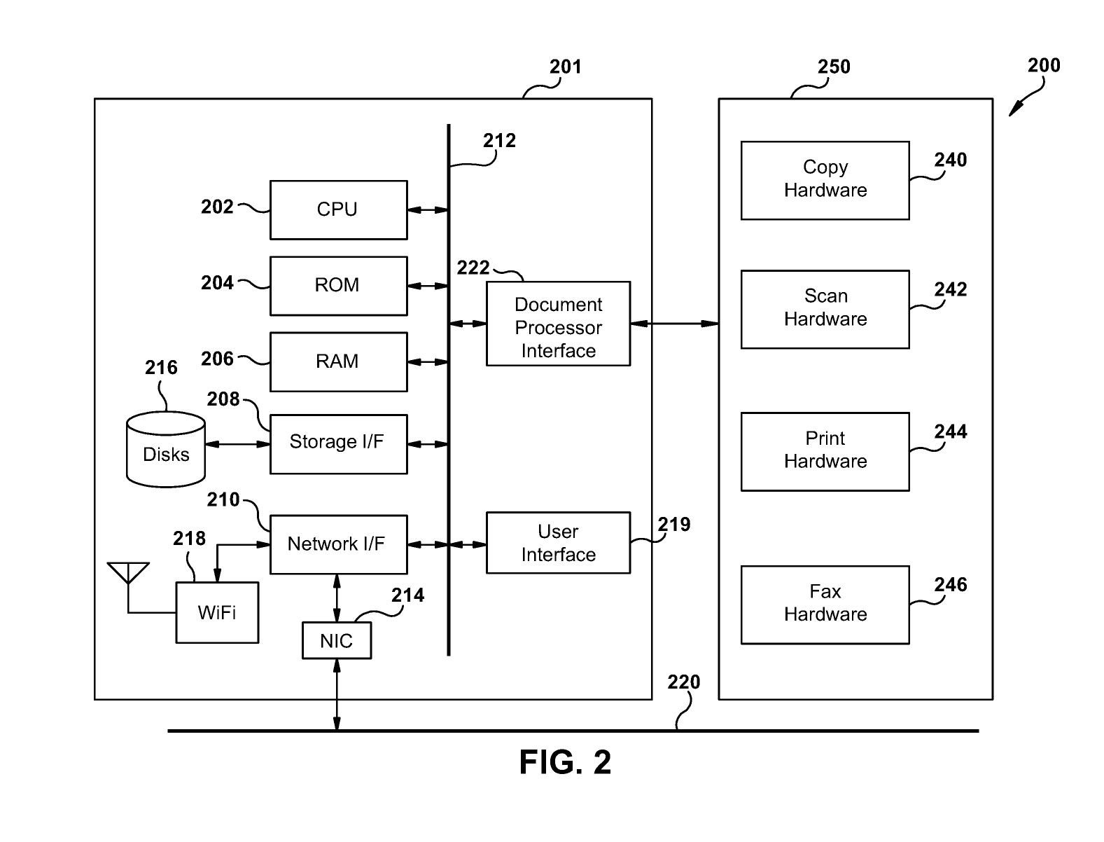

Turning now to FIG. 2 illustrated is an example embodiment of a networked digital device comprised of document rendering system 200 suitably comprised within an MFP, such as with MFP 132 of FIG. 1. It will be appreciated that an MFP includes an intelligent controller which is itself a computer system. Thus, and MFP can itself function as a cloud server with the capabilities descried herein. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with one or more sensors 219 which provide data relative to a state of the device or associated surroundings, such as device temperature, ambient temperature, humidity, device movement and the like. Hardware monitors suitably provide device event data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216 of FIG. 2.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with MFP functional units 250. In the illustrate example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

Controller 201 is suitably provided with an embedded web server system for device configuration and administration. A suitable web interface is comprised of TOPACCESS Controller (sometimes referred to in the subject illustrations as “TA”), available from Toshiba TEC Corporation.

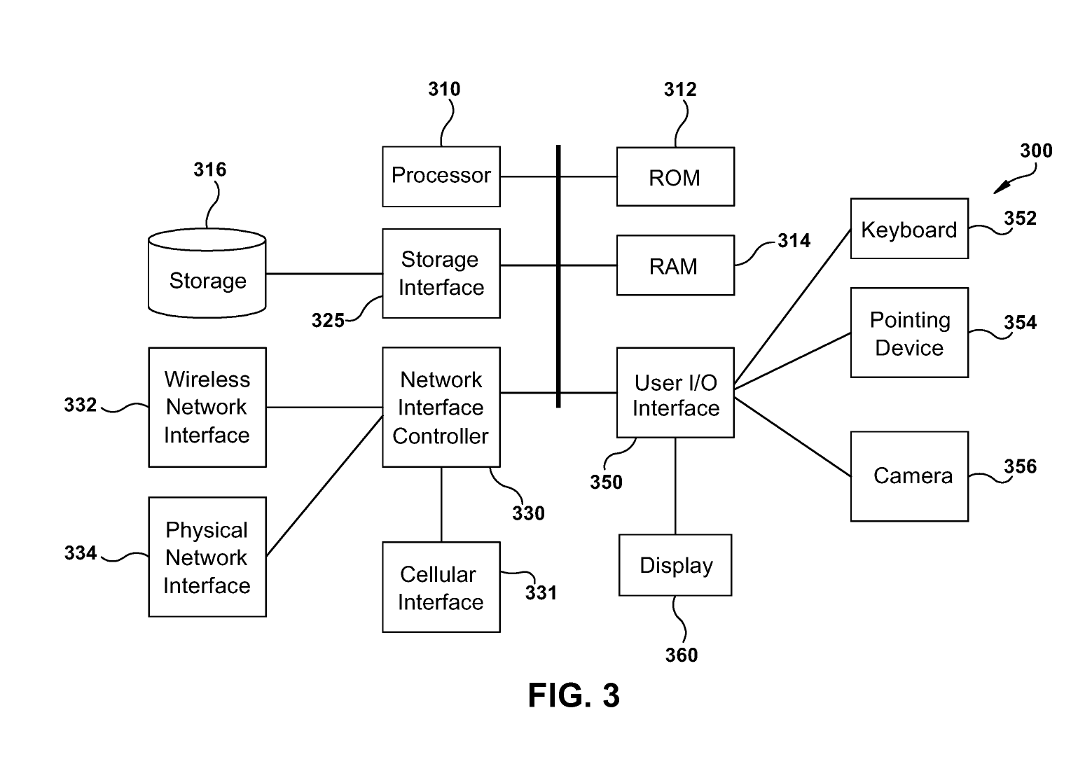

Turning now to FIG. 3, illustrated is an example embodiment of a digital data processing device 300, suitably comprising devices such as smartphone 140, tablet computer 154, notebook computer 158 or cloud server 150 of FIG. 1. Components of the data processing device 300 suitably include one or more processors, illustrated by processor 310, memory, suitably comprised of read-only memory 312 and random access memory 314, and bulk or other non-volatile storage 316, suitable connected via a storage interface 325. A network interface controller 330 suitably provides a gateway for data communication with other devices via wireless network interface 332 and physical network interface 334, as well as a cellular interface 231 such as when the digital device is a cell phone or tablet computer. A user input/output interface 350 suitably provides a gateway to devices such as keyboard 352, pointing device 354, and display 260, suitably comprised of a touch-screen display. It will be understood that the computational platform to realize the system as detailed further below is suitably implemented on any or all of devices as described above. A camera 356 is suitably included such as when the digital device is a camera or tablet computer.

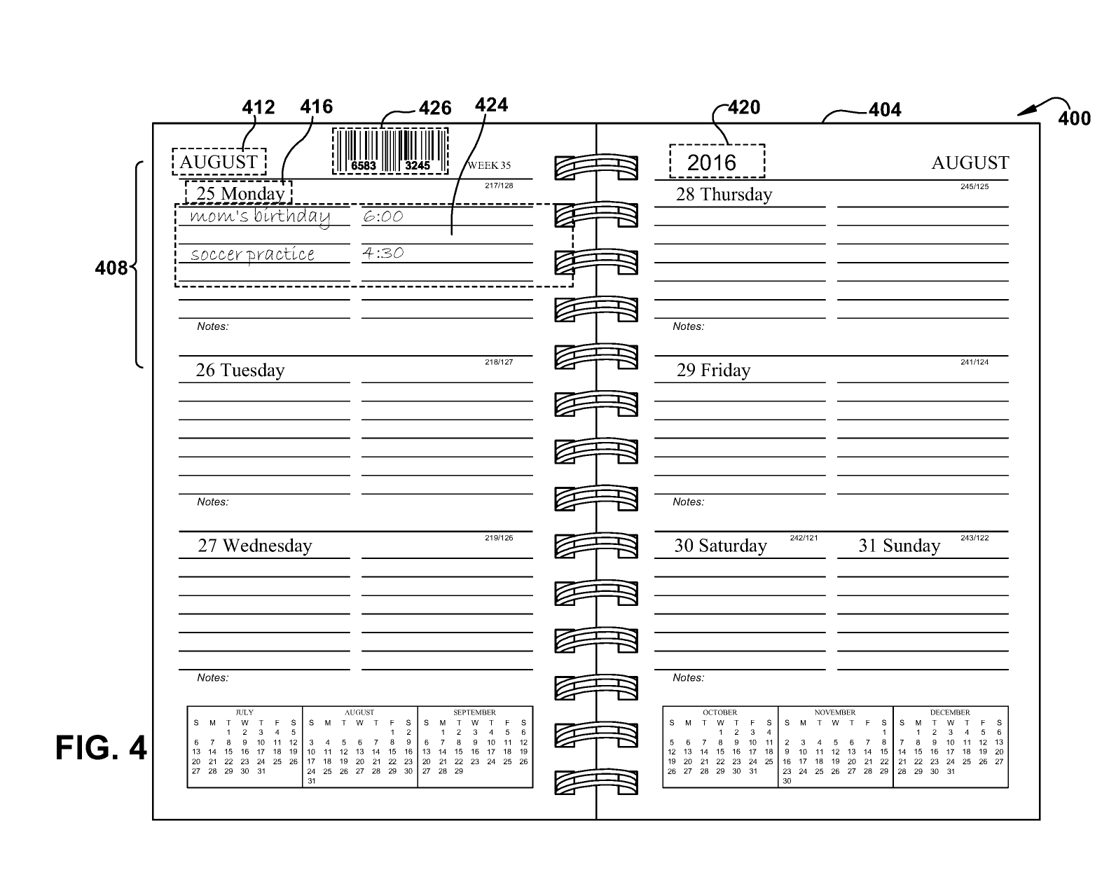

Referring next to FIG. 4, illustrated is an example embodiment of a paper calendar page set 400. Individual day locations, such as entry 408 corresponding to Monday, Aug. 25, 2016. Any suitable device, such as server 150 of FIG. 1, is programmed to look for temporal information indicative of time or dates. This is suitably performed by detecting words and numbers, and analyzing for patterns like date progression, page progression, month progression or day of week progression. By way of example, month field 412 is detected as containing August as a month candidate. Day/date field 416 is detected, along with year field 420. The system suitably extracts a true date by also verifying against known calendar information, such as that in 2016, the 25^{th} falls on a Monday. Field position, once detected, is suitably used to quickly associate other dates with associated information. In the illustrated example, data entry field 424 is associated with Monday, Aug. 25, 2016 and two appointments and associated times are captured. Once information is captured, along with corresponding temporal information, the system can quickly format it for importing into one or more electronic calendars. In the illustrated example, a bar code 426, such as a one-dimensional bar code as shown or a two-dimensional bar code such as a quick response or QR code, can be used to provide any suitable information such as date information or user identity information.

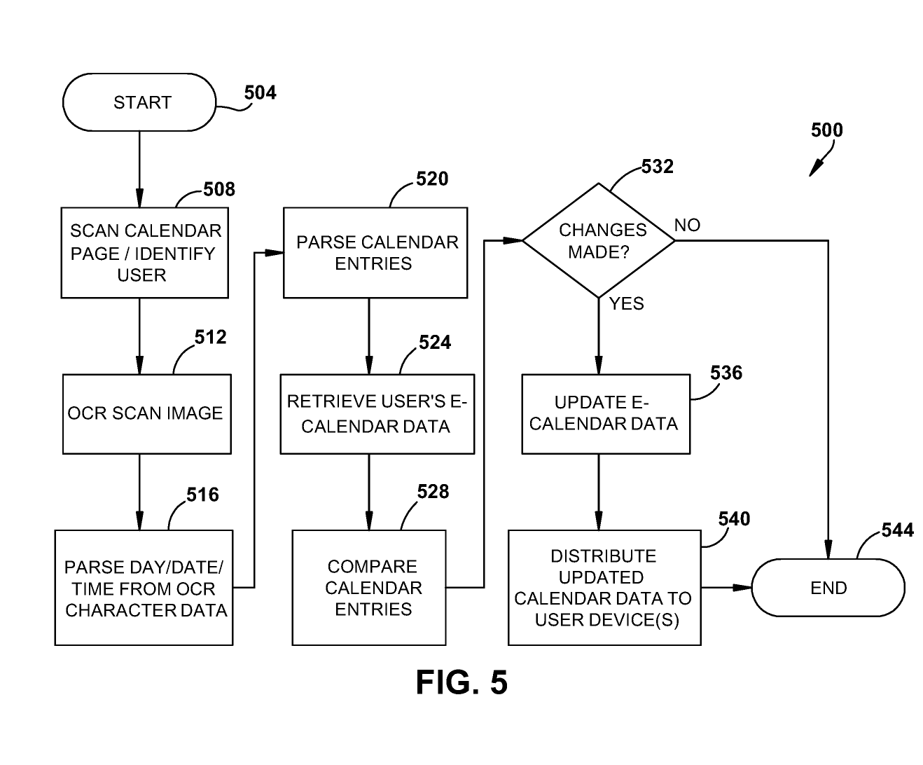

Turning now to FIG. 5, illustrated is a flowchart 500 of an example embodiment of a calendar conversion system. The system commences at block 504, and a calendar is scanned or photographed at block 508, and the resultant image is run through optical character recognition at block 512. Temporal information, such as time, day or date, is parsed from a resultant character inclusive file at block 516, and calendar entries are parsed at block 520. An identified user or users's calendar is retrieved at block 524, and entries from the image file are compared with electronic entries for the included periods at block 528. If changes are present as determined by block 532, the e-calendar is updated at block 536 to match the incoming data, and the resultant update is distributed to one or more devices at block 540. The process suitably ends at block 544. If no changes were detected at block 532, no updating is required and the process ends at block 544.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a memory configured to store schedule data in a data format corresponding to a scheduling application;
a digital imager configured to capture a digital image of a calendar page sheet into the memory; and
a processor configured to extract character data from the captured digital image,
the processor further configured to parse temporal data from the character data,
the processor further configured to determine a calendar entry date from parsed temporal data,
the processor further configured to parse event data from the character data, and
the processor further configured to update an electronic calendar entry for a determined calendar entry date with the event data.

2. The system of claim 1 wherein the processor is further configured to identify a user from the captured digital image.

3. The system of claim 2 wherein the processor is further configured to update the electronic calendar entry for an electronic calendar associated with the identified user.

4. The system of claim 3 wherein the processor is further configured to communicate the updated calendar entry to at least one networked data device associated with the identified user.

5. The system of claim 1 wherein the digital imager is comprised of a mobile phone camera.

6. The system of claim 1 wherein the digital imager is comprised of a scanner.

7. The system of claim 1 wherein the processor is further configured to update the electronic calendar entry for a calendar entry time determined from the parsed temporal data.

8. A method comprising:
storing schedule data in a data format corresponding to a scheduling application;
capturing a digital image of a calendar page sheet into a memory;
extracting character data from a captured digital image;
parsing temporal data from the character data;
determining a calendar entry date from the parsed temporal data;
parsing event data from the character data; and
updating an electronic calendar entry for a determined calendar entry date with the event data.

9. The method claim 8 further comprising identifying a user from the captured image data.

10. The method of claim 9 further comprising updating the electronic calendar entry for an electronic calendar associated with an identified user.

11. The method of claim 10 further comprising communicating the updated calendar entry to at least one networked data device associated with the identified user.

12. The method of claim 8 further comprising capturing the digital image via a mobile phone camera.

13. The method of claim 8 further comprising capturing the digital image via a scanner.

14. The method of claim 8 further comprising updating the electronic calendar entry for a calendar entry time determined from the parsed temporal data.

15. A device comprising:
a network interface configured to receive image data corresponding to a captured calendar page image; and
a processor and associated memory,
the processor configured to extract character data from received image data,
the processor further configured to parse temporal data from the character data,
the processor further configured to determine a calendar entry date from parsed temporal data,
the processor further configured to parse event data from the character data,
the processor further configured to update an electronic calendar entry for a determined calendar entry date with the event data, and
the processor further configured to send an updated calendar entry to an associated user device via the network interface.

16. The device of claim 15 wherein the processor is further configured to determine an event time associated with the event data from the parsed temporal data, and
wherein the processor is further configured to associate at least one event defined by the event data with a determined event time corresponding thereto.

17. The device of claim 16 wherein the processor is further configured to extract the character data via optical character recognition.

18. The device of claim 17 wherein the processor is further configured to identify the associated user from the received image data.

19. The device of claim 18 wherein the processor is further configured to identify the associated user from a bar code image contained in the received image data.

20. The device of claim 18 wherein the processor is further configured to identify the associated user from a user name contained in the character data.
